(19) United States
(12) Patent Application Publication
(10) Pub. No.: US 2014/0335305 A1
(43) Pub. Date: Nov. 13, 2014

(54) PIPE INSULATING COVER

(71) Applicant: Brendon Avery Syryda, Kelowna (CA)

(72) Inventor: Brendon Avery Syryda, Kelowna (CA)

(21) Appl. No.: 13/891,957

(22) Filed: May 10, 2013

(51) Int. Cl. F16L 59/02; B05D 3/00

(52) U.S. Cl. CPC F16L 59/029; F16L 59/028; B05D 3/00; B05D 2254/02
USPC 428/100; 428/99; 427/300

(57) ABSTRACT

An apparatus for covering a pipe component comprises a base layer having first and second edges sized and shaped to extend around a pipe such that the first and second edges are proximate to each other and a polymer layer applied over the base layer. The apparatus further comprises a first fastener applied to the first edge between the base layer and the polymer layer and a second fastener applied to the second edge between the first base layer and the polymer layer adapted to engage the first fastener. The apparatus may be formed by wrapping the sheet about a mold connecting the first and second fasteners together with a wire therebetween, applying the first fastener and second fasteners to the first and second edges, applying a layer of polymer over the first and second fasteners and removing the wire from between the first and second fasteners.

### BACKGROUND OF THE INVENTION

1. Field of Invention

The present invention relates generally to pipes in general and in particular to a method and apparatus for forming a pipe insulating cover.

2. Description of Related Art

In many industries, pipes or other elements are required to be protected and insulated from the weather or other elements. On common solutions for providing such protection is to insulate or otherwise cover the pipe to provide a thermal barrier between the pipe and the environment as well as to reduce water penetration to the pipe.

Disadvantageously, many such pipes are also required to be inspected or accessed periodically requiring removal of the insulation. Conventional pipe insulation is often formed by the pipe with a layer of insulation, such as, by way of non-limiting example, fiberglass matting, mineral wool or foams. Such insulation is commonly covered by a sheathing material, such as, by way of non-limiting example, sheet metal or fabric to maintain the shape of the insulation as well as to protect the insulating material from weather and damage.

Disadvantageously, conventional pipe insulation has been difficult to remove and reapply to a section or pipe element which may require maintenance or inspection. In particular, it may frequently be necessary to cut or otherwise remove the sheathing to access the pipe element. Such removal and reapplication of the sheathing and/or insulation may potentially damage the insulation, sheathing or both or may potentially create gaps or crack in the sheathing which permits water to penetrate the cover thereby potentially compromising the cover and damaging the pipe.

### SUMMARY OF THE INVENTION

According to a first embodiment of the present invention there is disclosed an apparatus for covering a pipe component comprising a base layer having first and second edges sized and shaped to extend around a pipe such that the first and second edges are proximate to each other and a polymer layer applied over the base layer. The apparatus further comprises a first fastener applied to the first edge between the base layer and the polymer layer and a second fastener applied to the second edge between the first base layer and the polymer layer adapted to engage the first fastener.

The polymer layer may be applied to the first fastener so as to leave a portion of the first fastener exposed. The first and second fasteners may comprise hook and loop fasteners. The first and second fasteners may comprise claps. The clasps may be secured to a strip embedded between the base layer and the polymer layer. The polymer layer may be formed of polyurea.

The first and second edges of the base layer may extend substantially parallel to an axis of the pipe component. The base layer may extend between first and second longitudinal ends wherein at least one of the first and second longitudinal ends includes a radially compressive collar. The compressive collar may comprise a strap extending around the first or second end. At least a portion of the strap may be embedded within the polymer layer.

The base layer may be formed of an insulating material. The base layer may be formed of a material selected from the group consisting of foam, aerogel, mineral wool and fiberglass insulating matting.

According to a further embodiment of the present invention there is disclosed a method of forming a pipe component cover comprising providing a sheet of a first insulating material sized to extend around the pipe component and locating a first fastener along a first edge of the sheet, and a second fastener along a second edge of the sheet. The method further comprises applying a layer of polymer over the sheet and the first fastener and at least a portion of the second fastener to imbed at least a portion of said first fastener between said base layer and said polymer layer.

The method further comprises wrapping the sheet about a mold so as to abut the first edge against the second edge thereof connecting the first and second fasteners together with a wire therebetween and applying the first fastener and second fasteners to the first and second edges. The method further comprises applying a layer of polymer over the first and second fasteners and removing the wire from between the first and second fasteners to separate the polymer layer at a junction between the first and second fasteners.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

In drawings which illustrate embodiments of the invention wherein similar characters of reference denote corresponding parts in each view,

FIG. 1 is a perspective view of an apparatus for covering a pipe component according to a first embodiment of the present invention.

FIG. 2 is a cross-sectional view of the apparatus of FIG. 1 taken along the line 2-2.

FIG. 3 is a cross-sectional view of the apparatus of FIG. 1 taken along the line 2-2 having clasps according to a further embodiment of the present invention.

FIG. 4 is a cross-sectional view of the apparatus of FIG. 1 taken along the line 4-4.

FIG. 5 is a perspective view of the apparatus of FIG. 1 at a first stage of construction

FIG. 6 is a perspective view of the apparatus of FIG. 1 applied around a mold at a second stage of construction.

FIG. 6 is a cross-sectional view of the apparatus of FIG. 1 having a wire being removed from between the fasteners at a third stage of construction.

FIG. 8 is a top perspective view of an apparatus for covering a pipe component according to a further embodiment of the present invention.

FIG. 9 is a bottom perspective view of an a apparatus for covering a pipe component according to a further embodiment of the present invention.

### DETAILED DESCRIPTION

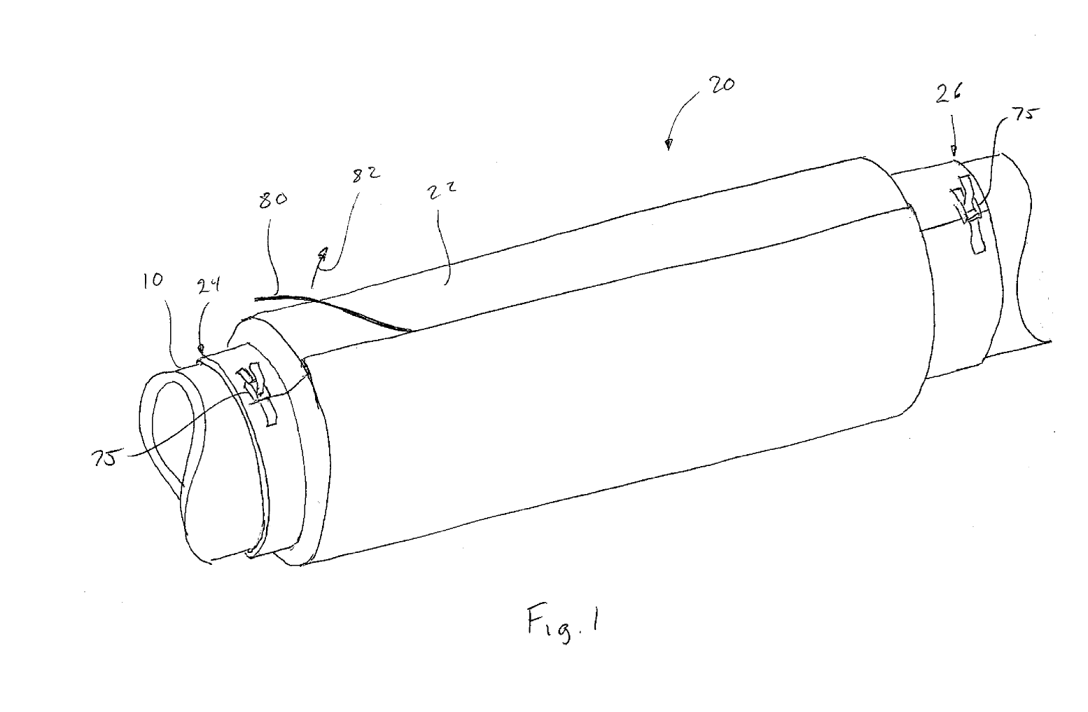

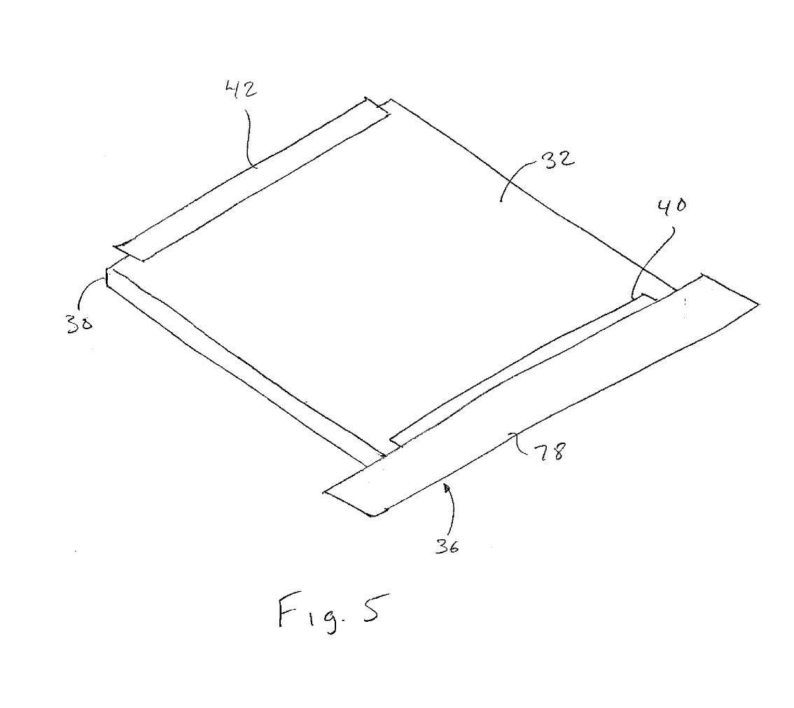

Referring to FIG. 1, an apparatus for covering a pipe component according to a first embodiment of the invention is shown generally at 20. As illustrated in FIG. 1, the pipe component may comprise a pipe section, although it will be appreciated that similar methods described below for forming the apparatus 20 may also be utilized for forming a cover to fit about an elbow section, a valve, t-fitting or any other element as are known in the art. The apparatus 20 comprises an elongate tubular member 22 extending between first and second ends, 24 and 26, respectively. The tubular member 22 has an outer surface 28 and an interior passage 30 (as illustrated in FIG. 4) extending therethrough between the first and second ends 24 and 26.

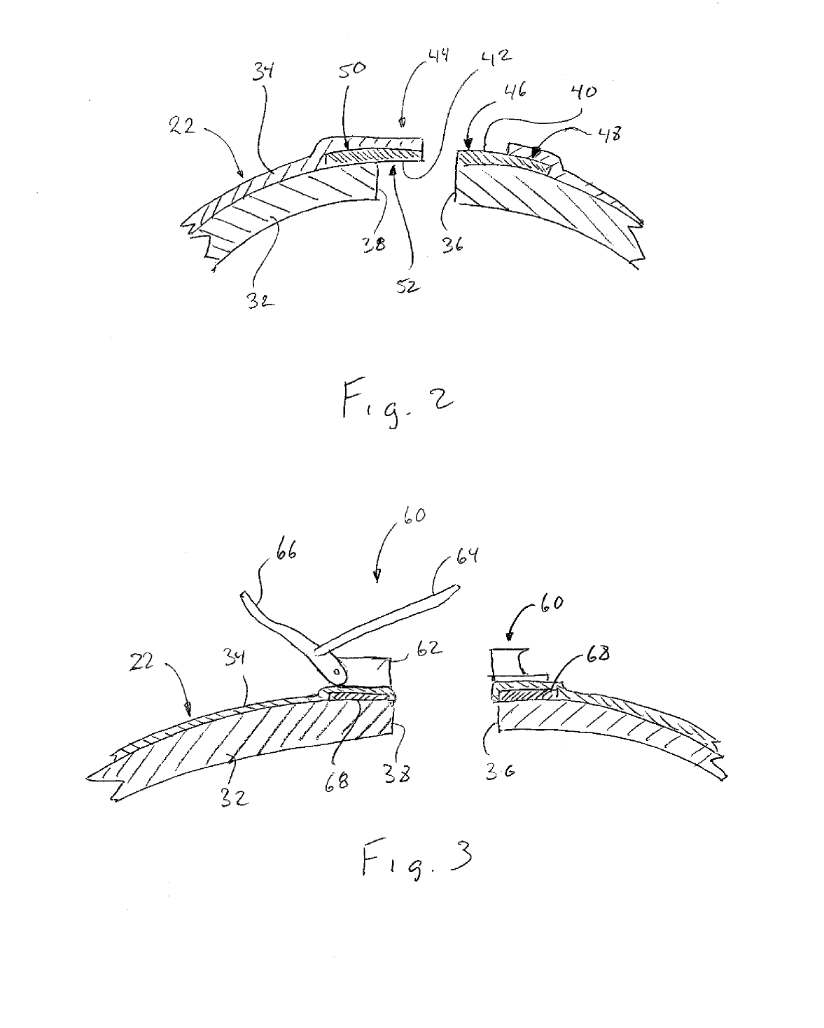

As illustrated in FIGS. 2-4, the tubular member 22 is formed of a first base layer 32 and a second polymer layer 34 applied thereover. The base layer 32 comprises a substantially planar sheet formed into the required cylindrical shape having first and second edges, 36 and 38, respectively. As further described below, the tubular member 22 is formed by locating the base layer 32 around a mold or otherwise to the desired shape and thereafter spraying, or otherwise applying the polymer layer 34.

The base layer 32 may be formed of any suitable insulating material, such as, by way of non-limiting example, expanded foam, aerogel fiberglass matting, mineral wool or the like. It will be appreciated that for applications required to withstand greater temperatures, fiberglass matting or mineral wool will be more appropriate. The polymer layer 34 is formed of a suitable polymer material which may be applied in a liquid form, such as, by way of non-limiting example, polyurea, polyurethane, other polymers and composite materials thereof and the like and when so applied will adhere directly to the base layer. It will be appreciated that the polymer layer 34 may be applied to the base layer by any suitable means, such as painting or spraying. It will also be appreciated that one or more layers of the polymer may be applied to the base layer to achieve the desired thickness and mechanical properties. In a tubular member 22 formed in such a manner, the base layer 32 will provide the desired insulating characteristics and may have a thickness and material selection required for such insulating properties. Additionally, the polymer layer 34 will provide waterproofing for the base layer 32 from the environment as well as providing strength to the tubular member and retaining the tubular member in the desired shape.

The first edge 36 of the tubular member 22 includes a first fastener component 40 disposed on the exterior surface thereof proximate to the first edge. The second edge 38 of the tubular member 22 includes a second fastener component 42 extending from the exterior surface thereof so as to form a flap 44 extending from the second edge 38. The second fastener component is adapted to overly and interconnect with the first fastener component so as to secure the second edge 38 of the tubular member 22 together to releasably hold each other together and may be selected from any commonly known connectors, such as, by way of non-limiting example, hook and loop fasteners, adhesive strips, zippers or the like.

As illustrated in FIG. 2, the polymer layer 34 is located so as to overly at least a portion of the first fastener when the first fastener is located proximate to the first edge 36. In particular, the polymer layer 34 may cover approximately half of the first fastener so as leave an exposed portion 46 and a covered portion 48 embedded within the polymer layer 34 between the polymer layer 34 and the base layer 32. The covered portion 48 serves to fix the first fastener in position within the polymer layer 34 at a position relative to the first edge 36. The exposed portion 46 provides a surface for the second fastener 42 to be adhered to. The second fastener 42 is located such that a first portion 50 of the second fastener is positioned on the base layer 32 and an second portion 52 extends therefrom as illustrated in FIG. 2. Thereafter the polymer layer 34 is applied over the entire second fastener to cover it. In such a configuration, the first portion 50 secures the second fastener 42 is secured within the polymer layer 34 at the desired position relative to the second edge 38 and the second portion 52 may be secured to the first fastener 40.

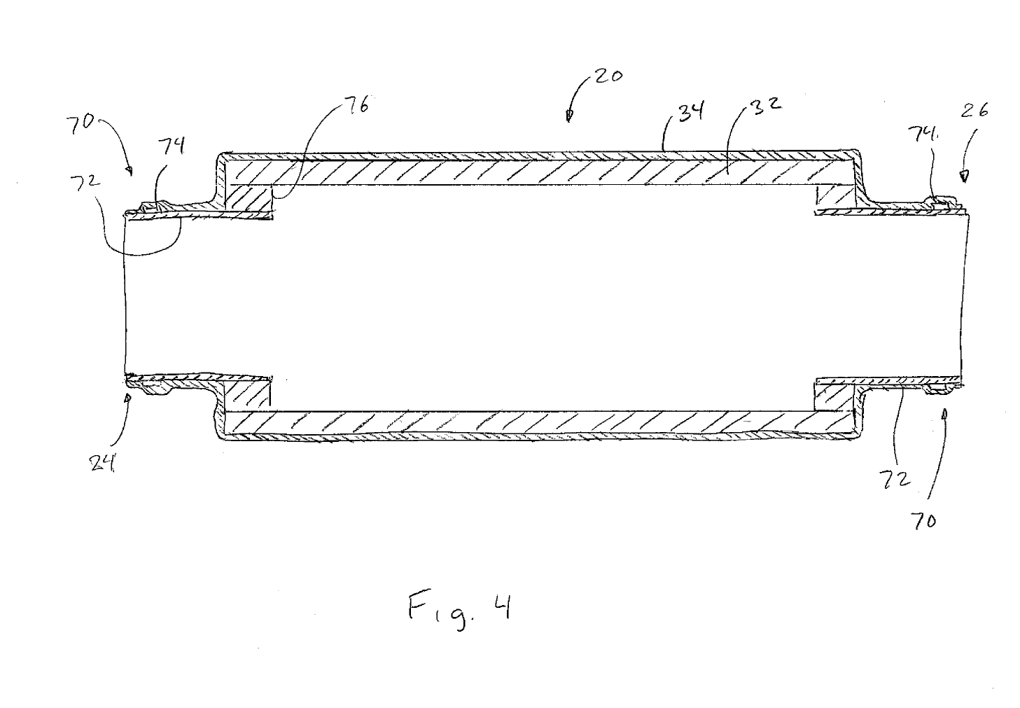

Optionally, as illustrated in FIG. 3, the first and second fasteners may comprise clasps 60 wherein a connection block 61 is secured proximate to the first edge 36 and a base block 62 is secured proximate to the second edge 38. The base block includes a loop 64 sized to extend around the connection block 61 and a handle 66 adapted to tighten and secure the loop 64 in position as are commonly known. Each of the first and second edges 36 and 38 may include a backing material 68 secured between the polymer and base layers 34 and 32 such as, by way of non-limiting example, a strip of aluminum, copper, steel, plastic or composite materials. The apparatus formed in such a manner may have the backing material 68 covered by the polymer layer 34 as set out above, wherein the connection block 61 and base block 62 thereafter secured thereto with fasteners, such as, rivets, screws or the like. Optionally, the connection block 61 and base block 62 may be secured to the backing material 68 secured thereto before applying the polymer layer 34 wherein the clasps 60 may be covered with tape or the like to prevent polymer from being applied thereto.

Turning now to FIG. 4, a longitudinal cross-sectional view of one embodiment is illustrated having end collars 70. The end collars 70 may be formed by sleeves 72 of fabric or other radially expandable materials extending from the ends of the base layer 32 with the polymer layer 34 sprayed or otherwise applied thereover. The end collars may optionally include tightening straps 74 extending therearound proximate to the first and second ends 24 and 26. As illustrated in FIGS. 1 and 4, the tightening straps 74 may be embedded between the polymer layer 34 and the sleeves 72 and may include tightening means, such as, by way of non-limiting example, buckles 75 or the like. As illustrated in FIG. 4, the sleeve 72 may extend from annular collars 76 applied around the interior of the base layer or may optionally extend from the base layer 32 itself. The annular collars 76 may be formed of a similar material as the base layer

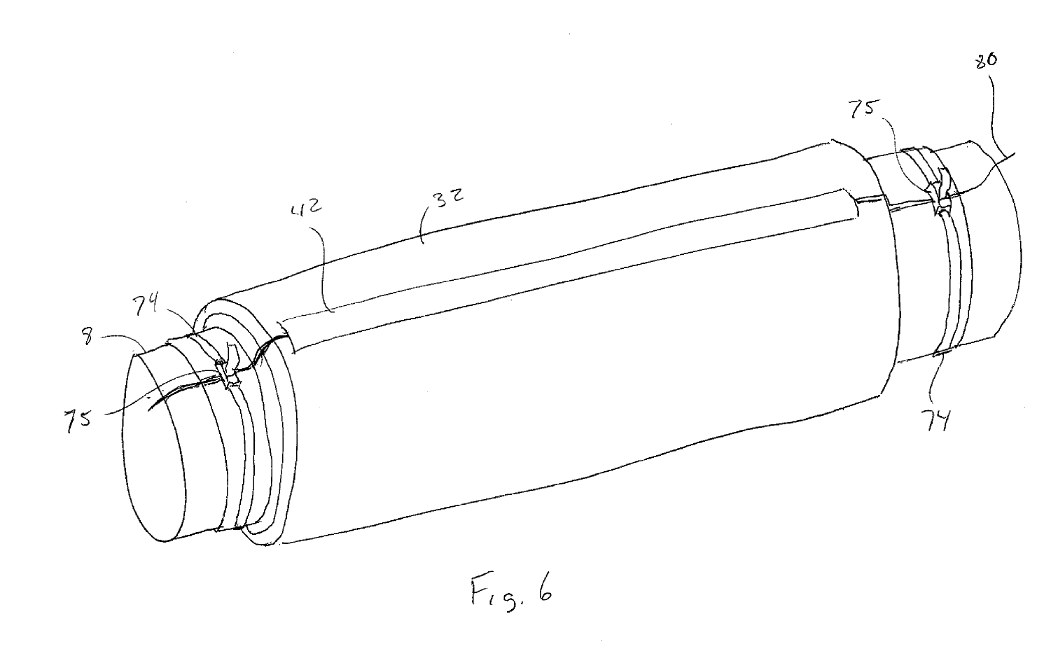

With reference to FIG. 5, the apparatus may be formed by cutting or otherwise selecting a sheet of the base layer material having a size sufficient to extend around the pipe component to be covered with the first and second edges 36 and 38 abutting. Thereafter the first and second fasteners 40 and 42 may be applied thereto and a portion of the first fastener 40 covered by a guard 78, such as, by way of non-limiting example, a sheet of paper metal or the like to cover the exposed portion 46. A layer of polymer material may then be applied to the base layer to cover covered portion 48 of the first fastener 40 and a portion of the second fastener 42 and base layer. It will be appreciated that although the entire base layer and exposed portions of the first and second fasteners may have the polymer layer 34 applied thereto at this stage, only a sufficient amount to adhere the first and second fasteners to the base layer 32 may also be utilized.

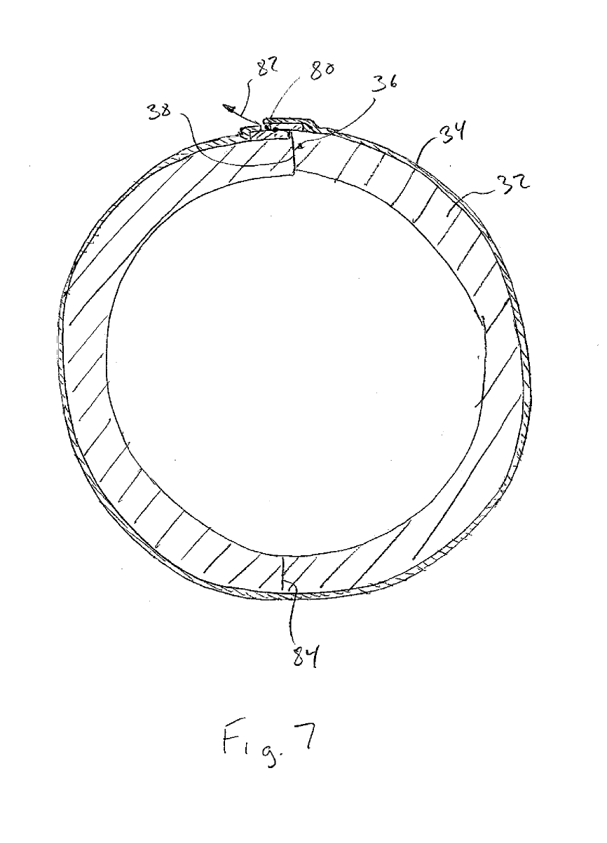

With reference to FIG. 6, the base layer may then be applied around a mold 8 having a shape corresponding to the pipe component to be covered along with the sleeves 72 and straps. Once positioned as desired, the first and second fasteners 40 and 42 may have a wire 80 located therebetween and be secured together as illustrated in FIG. 6. After the polymer layer 34 is applied to the apparatus 20, the wire 80 is quickly removed in a direction generally indicated at 82 before the polymer layer 34 has dried and cured so as to separate the first and second edges 36 and 38 from each other and permit the apparatus to be opened thereafter. As illustrated in FIG. 7, the base layer 32 may also optionally include a slot at a side opposite to the first and second edges 36 and 38 to assist with opening of the apparatus to locate it around pipe components and the like.

In operation, the apparatus may be opened by separating the first and second fasteners 40 and 42 from each other and opening the first and second edges 36 and 38 apart so as to pass the pipe component therethrough. Thereafter the first and second fasteners 40 and 42 may be secured together and the strap 74 secured around ends of the apparatus to seal and insulate the pipe component.

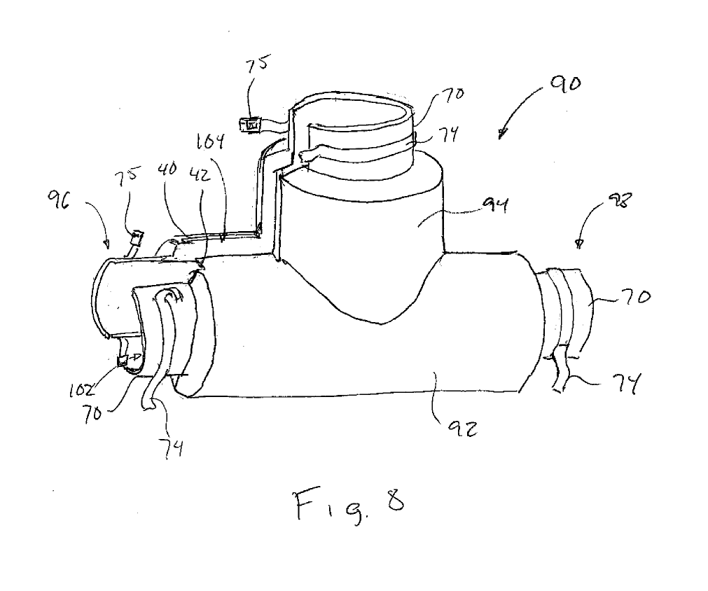

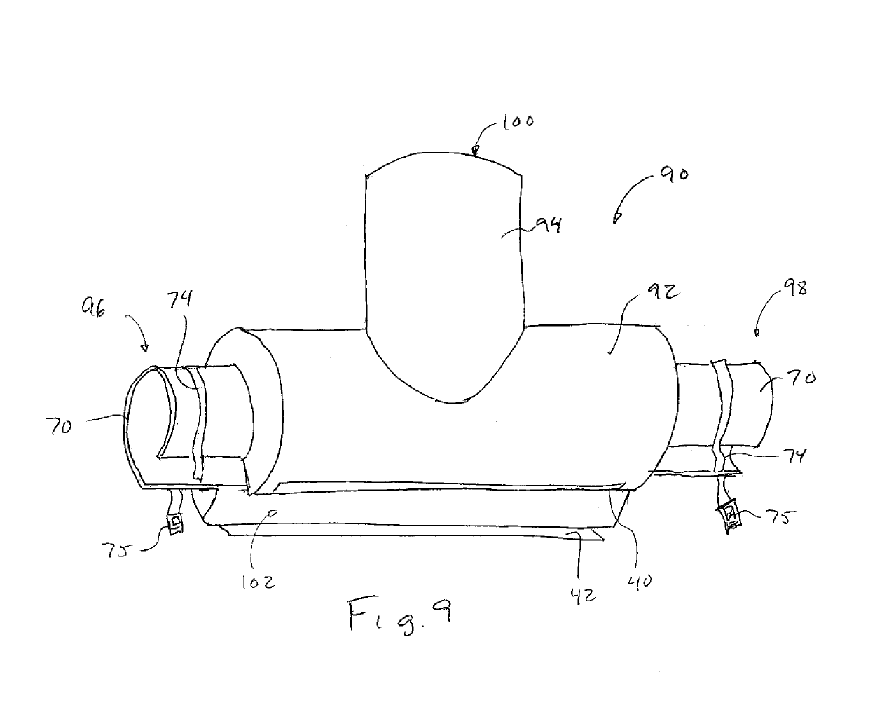

It will be appreciated that although the apparatus has been illustrated for use with substantially straight pipe components that similar methods may be utilized to form covers for corner or t-section components as well. By way of non-limiting example, a t-section cover 90 is illustrated in FIGS. 8 and 9 having a horizontal section 92 and an upright section 94 extending therefrom. The horizontal section extends between first and second ends, 96 and 98, respectively each having tightening straps 74 around end collars 70. The upright section 94 may include an end collar 70 and tightening strap 74 as illustrated in FIG. 8 for use with a t-pipe section or gate valve or may optionally have a substantially enclosed top end 100 as illustrated in FIG. 9. As illustrated in FIG. 8, the t-section cover 90 has an opening 102 along the bottom thereof with first and second fasteners 40 and 42 to either side thereof to permit the cover 90 to be opened and passed over the top of the pipe component. For embodiments where the cover 90 is intended to cover t-sections of pipe and the like, the cover may also include a top opening extending from one of the first or second ends 96 or 98 of the horizontal section to the end collar 70 of the top section to permit the cover to also be opened and the pipe passed therethrough into the interior of the cover. The t-section cover 90 may be formed of a plurality of sheets wherein at least one sheet of the base layer 32 is utilized for each of the horizontal section 92 and upright sections 94. It will also be appreciated that the t-section cover or straight cover 20 as described above may utilize pre-formed tubular insulation sections in place of flat sheets of insulation. Additionally, it will be appreciated that the material for the base layer 32 of the horizontal portion 92 will have a portion removed corresponding to the interior passage of the upright section 94 to provide a common interior space within the cover wherein the upright section 94 may have a bottom end coped to correspond to the shape of the horizontal portion 92.

While specific embodiments of the invention have been described and illustrated, such embodiments should be considered illustrative of the invention only and not as limiting the invention as construed in accordance with the accompanying claims.

What is claimed is:

1. An apparatus for covering a pipe component comprising:
a base layer having first and second edges sized and shaped to extend around a pipe such that said first and second edges are proximate to each other;
a polymer layer applied over said base layer; and
a first fastener applied to said first edge between said base layer and said polymer layer; and
a second fastener applied to said second edge between said first base layer and said polymer layer adapted to engage said first fastener.

2. The apparatus of claim 1 wherein said polymer layer is applied to said first fastener so as to leave a portion of said first fastener exposed.

3. The apparatus of claim 1 wherein said first and second fasteners comprise hook and loop fasteners.

4. The apparatus of claim 1 wherein said first and second fasteners comprise claps.

5. The apparatus of claim 4 wherein said clasps are secured to a strip embedded between said base layer and said polymer layer.

6. The apparatus of claim 1 wherein said polymer layer is formed of polyurea.

7. The apparatus of claim 1 wherein said first and second edges of said base layer extend substantially parallel to an axis of said pipe component.

8. The apparatus of claim 1 wherein said base layer extends between first and second longitudinal ends wherein at least one of said first and second longitudinal ends includes a radially compressive collar.

9. The apparatus of claim 8 wherein said compressive collar comprises a strap extending around said first or second end.

10. The apparatus of claim 9 wherein at least a portion of said strap is embedded within said polymer layer.

11. The apparatus of claim 1 wherein said base layer is formed of an insulating material.

12. The apparatus of claim 11 wherein said base layer is formed of a material selected from the group consisting of foam, aerogel, mineral wool and fiberglass insulating matting.

13. A method of forming a pipe component cover comprising:
providing a sheet of a base layer sized to extend around the pipe component;
locating a first fastener along a first edge of said sheet, and a second fastener along a second edge of said sheet;
applying a layer of polymer over said sheet and said first fastener and at least a portion of said second fastener to imbed at least a portion of said first fastener between said base layer and said polymer layer.

14. The method of claim 13 further comprising:
wrapping said sheet about a mold so as to abut said first edge against said second edge thereof;
connecting said first and second fasteners together with a wire therebetween;
applying said first fastener and second fasteners to said first and second edges,
applying a layer of polymer over said first and second fasteners; and
removing said wire from between said first and second fasteners to separate said polymer layer at a junction between said first and second fasteners.

15. The method of claim 13 wherein said providing at sheet of a base layer comprises selecting a suitable length of a pre-formed tubular insulation corresponding to the pipe component.
